(19) United States
(12) Patent Application Publication
(10) Pub. No.: US 2016/0333938 A1
(43) Pub. Date: Nov. 17, 2016

(54) RETAINER SYSTEM

(71) Applicant: GM GLOBAL TECHNOLOGY OPERATIONS LLC, Detroit, MI (US)

(72) Inventor: Norman Parker, Clarkston, MI (US)

(21) Appl. No.: 14/709,707

(22) Filed: May 12, 2015

(51) Int. Cl. F16C 35/067; F16C 35/04; F16B 7/04

(52) U.S. Cl. CPC F16C 35/067; F16B 7/042; F16C 35/042

(57) ABSTRACT

A retainer system for retaining a member in an opening comprises a retainer comprising a sleeve having an outer dimension toleranced to fit within the opening, inwardly of the mouth thereof. At least one deflectable retaining nub is formed on the sleeve and extends radially inwardly between a first edge and a second edge, wherein the retainer is configured to allow passage of the member therethrough as the retaining nub deflects radially outwardly towards the inner wall of the opening and, wherein the deflectable retaining nub returns to its radially inwardly extending position when the member has cleared the retaining nub, locking the member in position in the opening.

### FIELD OF THE INVENTION

The subject of the invention relates to retaining parts within sub-assemblies and, more particularly, to a system and method for installing a member such as a bearing, a shaft or the like, in an opening or sleeve.

### BACKGROUND

In the design and assembly of mechanical systems it is common to assemble bearing supported, rotating shafts into devices such as transfer cases, transmissions, engines, wheel hubs, torque tubes and other assemblies that transfer rotation. In such cases it is quite often the case that a bearing is disposed between a non-rotating housing and a rotating shaft. When mounting the bearing in a housing, for instance, the bearing may be mounted on an end of a shaft and may be subject to insertion into a blind opening that has been machined or otherwise formed in the housing. The blind opening is configured to accept the bearing and/or bearing assembly (i.e. a bearing commonly comprises multiple components such as an inner race, an outer race and balls or rollers disposed therebetween) and shaft therein. Retention of the bearing assembly in the blind opening is commonly achieved using a spring clip or other similar device that is inserted into the opening and is seated in a groove, in the wall of the opening, on the outboard side of the bearing. In order to install such a spring clip, special tools are required as is free access to the opening. Installation of a retaining member such as a spring clip is problematic when tool access is blocked by other components such as gears, or the like, that may be mounted in close proximity to the opening. It would be desirable to have a retaining system and method for installing a bearing or other cylindrical member in a blind opening that does not require tool access.

### SUMMARY OF THE INVENTION

In an exemplary embodiment a retainer system for fixedly retaining a member in an opening having an inner wall comprises a retainer comprising a sleeve having an outer dimension toleranced to fit within the inner wall, inwardly of the mouth of the opening, a first edge and a second edge defining a height “H” of the sleeve and at least one deflectable retaining nub formed on the sleeve and extending radially inwardly from the sleeve between the first edge and the second edge, wherein the retainer is configured to allow passage of the member therethrough, the retaining nub deflecting radially outwardly towards the inner wall of the opening and, wherein the deflectable retaining nub returns to its radially inwardly extending position, when the member has cleared the retaining nub, locking the member in position in the opening.

In another exemplary embodiment, a retainer system for fixedly retaining a bearing assembly in a housing comprises a housing including at least one opening having a mouth and defined by an inner wall and a retainer comprising a sleeve having an outer dimension toleranced to fit within the inner wall, inwardly of the mouth, a first edge and a second edge and at least one deflectable retaining nub formed on the sleeve, and extending radially inwardly from the sleeve, between the first edge and the second edge, wherein the retainer is configured to allow passage of a bearing assembly therethrough, the deflectable retaining nub deflecting radially outwardly towards the inner wall of the opening and wherein the deflectable retaining nub returns to its radially inwardly extending position, when the bearing assembly has cleared the deflectable retaining nub, locking the bearing assembly in position in the opening of the housing.

In yet another embodiment, a retainer system for mounting a bearing assembly supported rotatable shaft in a tubular opening is disclosed. The retainer system has a shaft support comprising a sleeve having an inner dimension “D1” toleranced to fit about the outer diameter of the rotatable shaft and an outer dimension “d1” toleranced to fit within an inner diameter of an inner race of the bearing assembly. First and second axially spaced deflectable retaining nubs are formed on the sleeve and extend radially outwardly from the sleeve between a first edge and a second edge such that the axial distance between the deflectable retaining nubs is equal to a bearing height “h”, wherein the rotatable shaft with the shaft support in place is insertable into the bearing inner race and the first deflectable retaining nub is deflected radially inwardly towards the outer surface of the rotatable shaft until the first retaining nub is pressed past the bearing inner race and the second retaining nub seats against the bearing inner race to thereby lock the shaft in position in the bearing assembly, and the tubular passage, when the first deflectable retaining nub of the shaft support springs back into position in the radially outwardly extending position.

The above features and advantages, and other features and advantages of the invention, are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a partial sectional view of a retainer system embodying features of the invention;

FIG. 2 is an isometric view of a retainer embodying features of the invention;

FIGS. 3A, 3B & 3C are schematic sectional views of the retainer system of FIG. 1 illustrating the sequence of installation of a bearing assembly into an opening having a retainer embodying features of the invention;

FIG. 4 is an isometric view of another embodiment of a retainer embodying features of the invention;

FIG. 5 is a schematic sectional view of the retainer system case of FIG. 1 illustrating the installation of the retainer of FIG. 4;

FIG. 6 is an isometric view of another embodiment of a retainer embodying features of the invention;

FIG. 7 is a schematic sectional view of a tubular member illustrating the installation of the retainer of FIG. 6;

FIG. 8 is an isometric view of a shaft support embodying features of the invention; and

FIG. 9 is a schematic sectional view of a tubular member illustrating the installation of the shaft support of FIG. 8.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term vehicle is not limited to just an automobile, truck, van or sport utility vehicle, but includes any self-propelled or towed conveyance suitable for transporting a burden. The embodiments shown may be applicable to vehicle components, but the system disclosed herein may be used in any suitable applications in which components are subject to support in corresponding openings (ex. transportation, energy, machinery and aerospace applications, and particularly including many other types of vehicular components and applications).

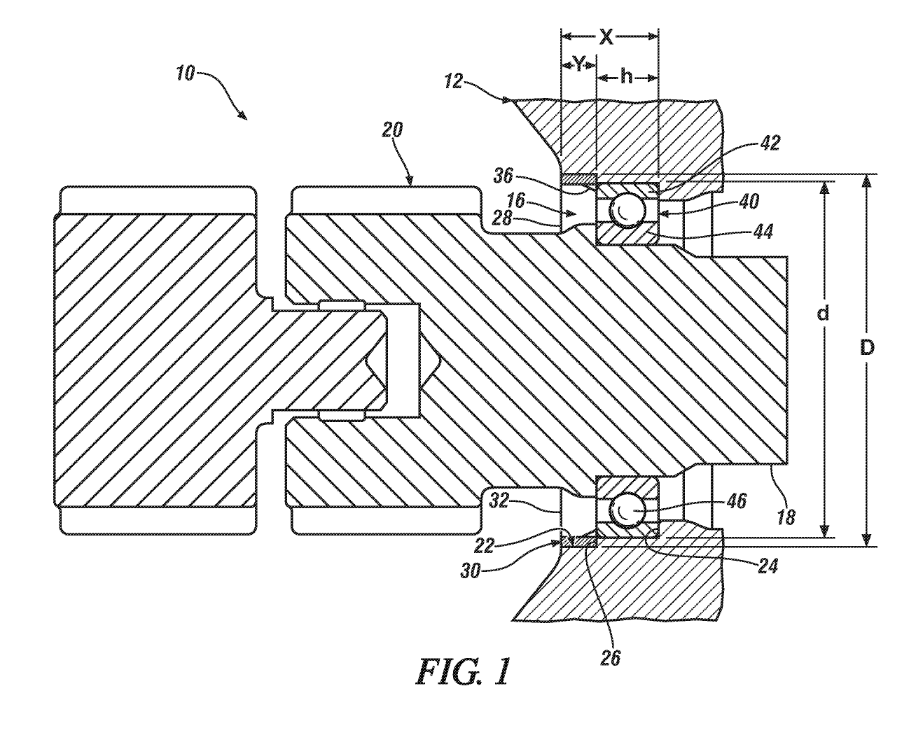

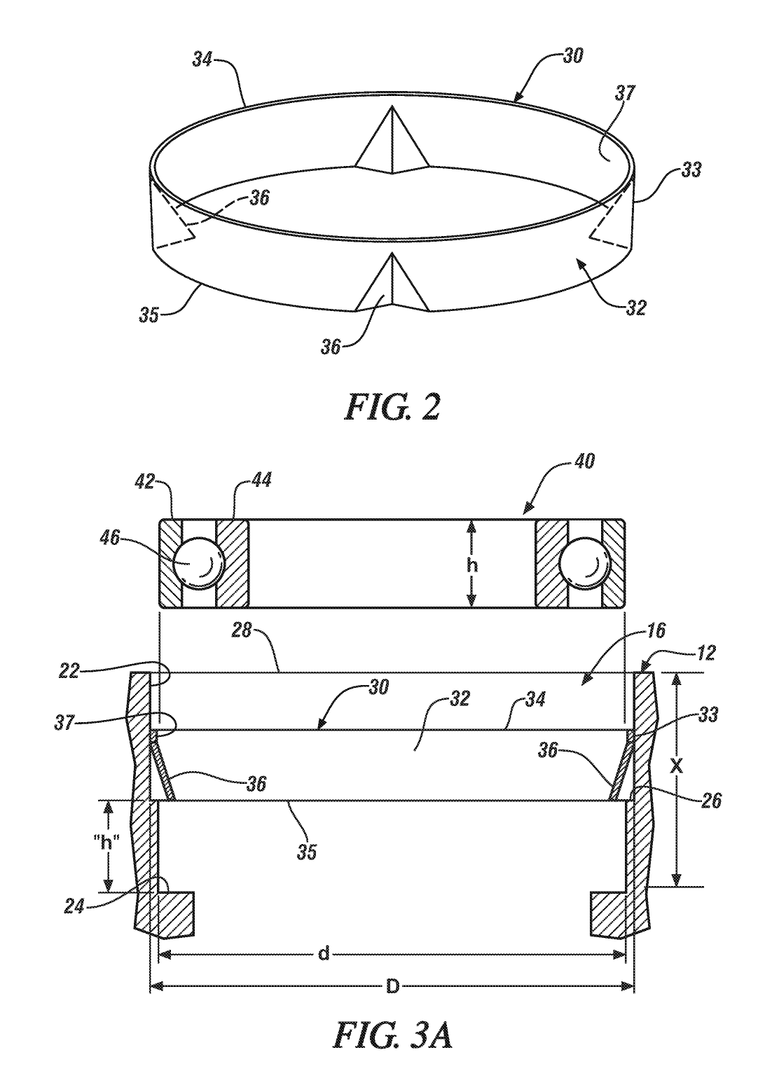

Referring now to FIGS. 1 and 2, in an exemplary embodiment, a mechanical device 10 is illustrated comprising a housing 12. The housing of the mechanical device 10 may contain mechanisms for rotation therein (not shown). In an embodiment, the mechanical device 10 is a transfer case for application in a motor vehicle. The housing 12 includes at least one opening 16 formed therein. The opening 16 is defined by an inner wall 22 that is configured, as will be described in further detail herein, to receive a first end 18 of a rotatable shaft 20. The rotatable shaft 20 may have a splined first end that is configured to engage gears (not shown) or other drivers that are rotatably operable within the housing 12 to thereby impart a rotation to the shaft 20.

In an embodiment, a retainer system includes a retainer 30 comprising a sleeve 32 that may be constructed from a thin walled tube of sheet steel, plastic, composite or other suitable material. The outer dimension 33 of the sleeve 32 is toleranced to fit within the inner wall 22 of the opening 16 of the housing 12. At least one deflectable retaining nub 36 is formed on the sleeve 32 of the retainer 30 and extends radially inwardly from the sleeve between the first edge 34 and the second edge 35. The deflectable retaining nub 36, in an embodiment, may be stamped into the round sleeve during the forming of the retainer 30.

In an embodiment, an insertable member such as bearing assembly 40, may comprise any number of configurations. Generally a shaft mounted bearing includes an outer race 42, an inner race 44 and bearing members 46 disposed between the inner and outer races to allow rotation therebetween. The bearing assembly has a height “h”.

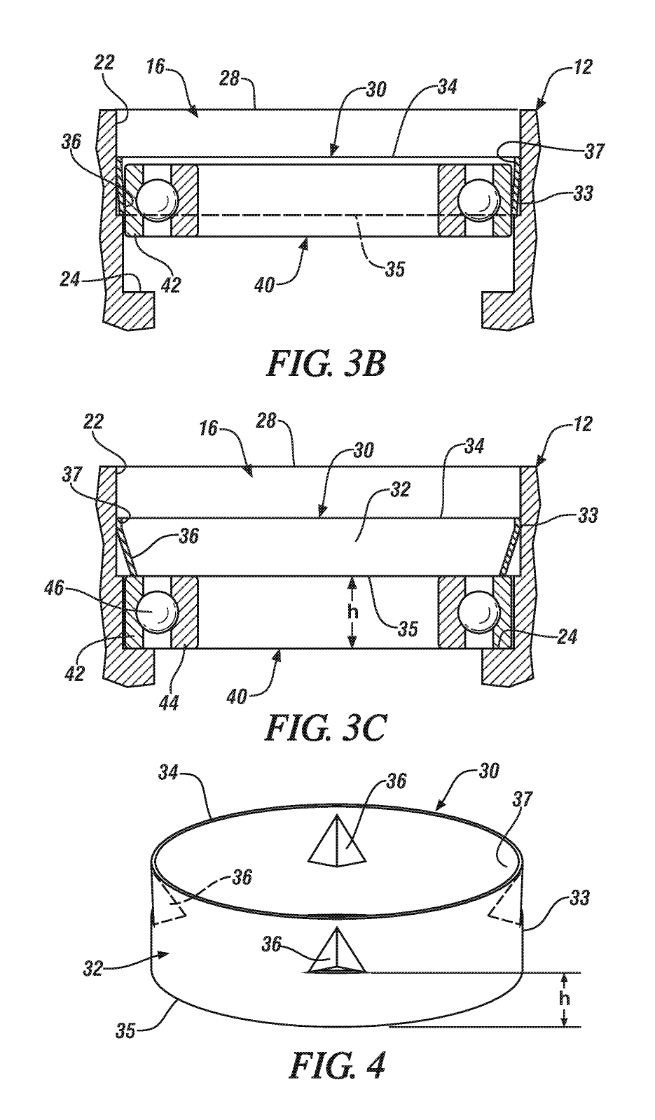

Referring now to FIGS. 3A-3C, with continuing reference to FIGS. 1 and 2, in one exemplary embodiment, the inner wall 22 of the opening 16 includes an inner stop 24 spaced a distance from the mouth 28 of the opening 16. An outer stop 26 is also disposed in the inner wall 22 of the opening 16 and is disposed a distance “Y” from the mouth 28 wherein (x>y), the difference being equal to a bearing height “h”. The diameter “d” of the inner wall 22 in the region between the inner stop 24 and the outer stop 26 is less than the diameter “D” of the inner wall 22 in the region between the outer stop 26 and the mouth 28 of the opening 16. More specifically, the diameter “d” of the inner wall 22 in the region between the inner stop 24 and the outer stop 26 is equal to or less than the outer dimension of the outer race 42 of the bearing assembly 40 and the diameter “D” of the inner wall 22 in the region between the outer stop 26 and the mouth 28 of the opening 16 is equal to or less than the outer dimension 33 of the sleeve 32 of the retainer 32.

In the described embodiment, the retainer 30 is inserted into the opening 16 and is seated against the outer stop 26 with the retaining nub or nubs 36 extending radially inwardly. Depending upon the outer dimension 33 of the sleeve 32, the retainer 30 may be press-fit in place. With the retainer 30 in place, the bearing assembly 40 is inserted into the opening 16 and pressed through and past the retainer 30, FIGS. 3B and 3C. In the embodiment described, the outer dimension of the bearing outer race 42 is less than the inner dimension 37 of the sleeve 32 of the retainer 30. As the outer race 42 of the bearing assembly 40 contacts the deflectable retaining nub 36 of the retainer 30, the nub is deflected radially outwardly towards the inner wall 22 of the opening 16, FIG. 3B, allowing the bearing to pass inwardly of the retainer 30 and to seat against the inner stop 24. Once the outer race 42 of the bearing 40 has cleared the retaining nub or nubs 36 of the retainer 30 it will spring back into position in the radially inward position to thereby lock the bearing assembly 40 in position within the opening 16, FIG. 3C, between the deflectable retaining nub or nubs 36 and the inner stop 24.

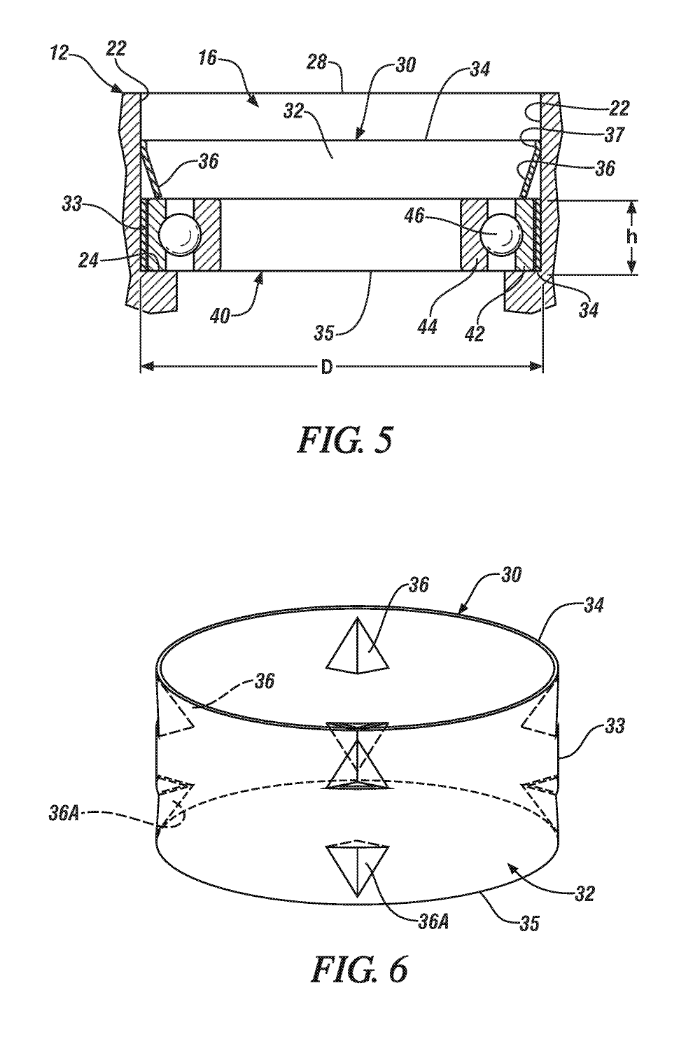

In another embodiment, and referring to FIGS. 4 and 5, with continuing reference to FIG. 1, the inner wall 22 of the opening 16 includes an inner stop 24. The retainer 30 comprises sleeve 32, the outer dimension 33 of which is toleranced fit within diameter “D” of the inner wall 22 in the region between the inner stop 24 and the mouth 28 of the housing 12. At least one deflectable retaining nub 36 is formed on the sleeve 32 of the retainer 30 and extends radially inwardly from the sleeve and is located axially between the first edge 34 and the second edge 35 of the sleeve 32 such that the height of the region between the retaining nub 36 and the second edge 35 is equal to the bearing height “h”.

As illustrated in FIG. 5, the retainer 30 is inserted into the opening 16 and is seated against the inner stop 24 with the deflectable retaining nub or nubs 36 extending radially inwardly. Subsequently, and as described with respect to the above embodiment, the bearing assembly 40 is inserted into the opening 16 and pressed into the retainer sleeve 32. As the outer race 42 of the bearing assembly 40 contacts the deflectable retaining nub or nubs 36 of the retainer 30, the nub is deflected radially outwardly towards the inner wall 22 of the opening 16, allowing the bearing to pass the deflectable retaining nub or nubs 36 and to seat against the inner stop 24. Once the outer race 42 of the bearing 40 has cleared the deflectable retaining nub or nubs 36 of the retainer 30 it springs back into position in the radially inwardly extending position to thereby lock the bearing 40 in position within the region between the retaining nub 36 and the second edge 35 of the sleeve 32 within the opening 16, FIG. 5. In the embodiment illustrated, the outer race 42 of the bearing 40 is seated within the sleeve 32 of the retainer 30 thereby eliminating the requirement for machining two stops in the inner wall 22 and simplifying tolerance machining since the tolerance required to retain the bearing assembly 40 is borne by the retainer 30.

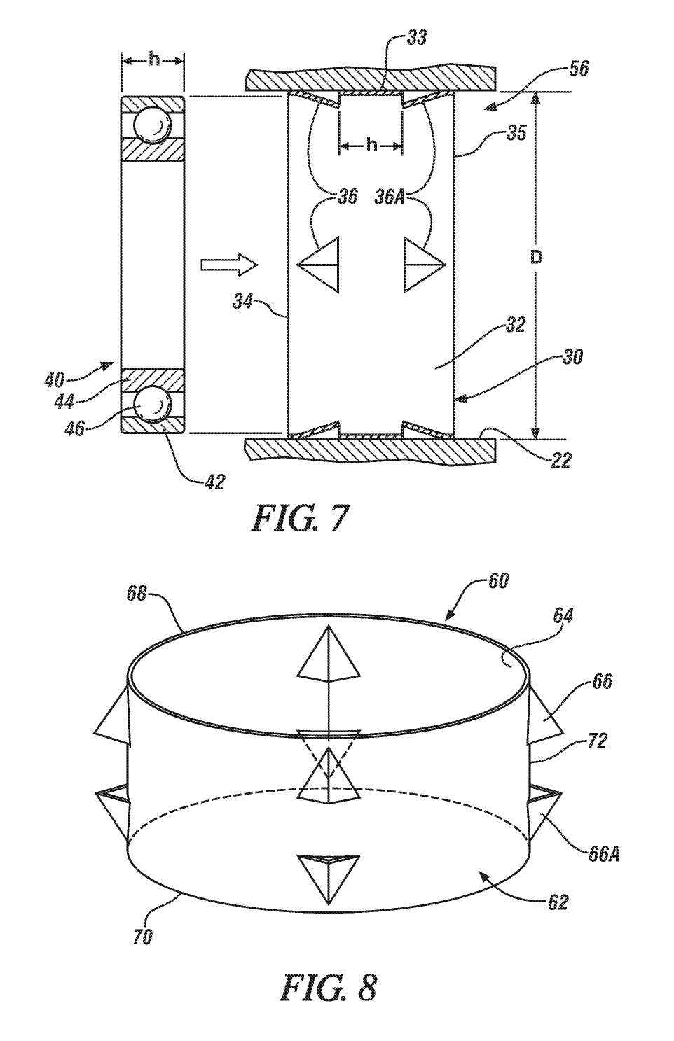

In a further embodiment, and referring to FIGS. 6 and 7, it is desired to mount a bearing assembly 40 in a tubular opening 56 for the support of a bearing in a torque tube, for instance. A retainer 30 may comprise a sleeve 32 in which the outer dimension 33 is toleranced to fit within diameter “D” of the inner wall 22 of the tubular opening 56. First and second axially spaced deflectable retaining nubs 36, 36A are formed on the sleeve 32 of the retainer 30 and extend radially inwardly from the sleeve between first edge 34 and a second end 35 such that the axial distance between the deflectable retaining nubs 36, 36A is equal to the bearing height “h”. The retaining nubs 36, 36A, in an embodiment, may be stamped into the sleeve during the forming of the retainer 30. As illustrated in FIG. 7, the retainer 30 may be press fit or otherwise fixed (ex. adhesive, welding) into the tubular opening 56 with the deflectable retaining nubs 36, 36A extending radially inwardly.

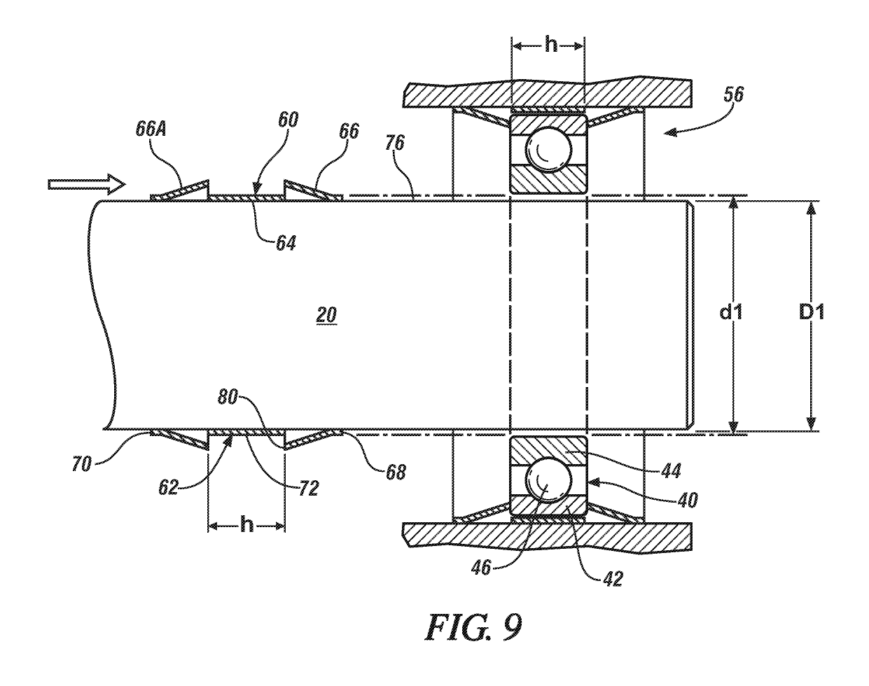

With the retainer 30 in place in the tubular opening 56, the bearing assembly 40 is inserted therein and is pressed past the first deflectable retaining nub 36 of the retainer 30. As the outer race 42 of the bearing assembly 40 contacts the deflectable retaining nub 36 the nub is deflected radially outwardly towards the inner wall 22 of the tubular opening 56, allowing the bearing to pass the deflectable retaining nub 36 and to seat against the second, axially spaced retaining nub 36A. Once the outer race 42 of the bearing assembly 40 has cleared the deflectable retaining nub 36 (or nubs) of the bearing retainer 30 it will spring back into position in the radially inwardly extending position to thereby lock the bearing assembly 40 in position within the sleeve 32 of the retainer 30 and, as such, the tubular member 56, FIG. 9. More specifically, the outer race 42 of the bearing assembly 40 is seated within the sleeve 32 of the retainer 30 with the tolerance required to retain the bearing assembly 40 borne by the bearing retainer 30.

In an alternate embodiment, and referring to FIGS. 8 and 9, it may be desired to mount a bearing supported rotatable shaft 20 in a tubular opening 56 such as, for instance, the support of a prop shaft in the inner race 44 of bearing assembly 40. A shaft support 60 comprises a sleeve 62 that may be constructed from a thin walled tube of sheet steel, plastic, composite or other suitable material. The inner dimension 64 of the sleeve 62 is toleranced to fit about the outer diameter “D1” of the rotatable shaft 20. First and second axially spaced deflectable retaining nubs 66, 66A are formed on the sleeve 62 of the shaft support 60 and extend radially outwardly from the sleeve between a first edge 68 and a second edge 70 thereof, such that the axial distance between the retaining nubs 66, 66A is equal to the bearing height “h”. The deflectable retaining nubs 66,66A, in an embodiment, may be stamped into the sleeve during the forming of the shaft support 60. As illustrated in FIG. 9, the shaft support 60 may be press fit or otherwise fixed (ex. adhesive, welding) onto the shaft 20 with the deflectable retaining nubs 66, 66A extending radially outwardly. In addition, the diameter “d1” defined by the outer dimension 72 of the sleeve 62 of the shaft support 60 extending between the deflectable retaining nubs 66, 66A is toleranced to fit within inner diameter of the bearing inner race 44.

With the shaft support 60 in place on the rotatable shaft 20, the shaft is inserted into the bearing inner race 44 until the deflectable retaining nub or nubs 66 of the shaft support 60 are pressed past the inner race 44 of the bearing assembly 40. As the inner race 44 of the bearing assembly 40 contacts the deflectable retaining nub 66 the nub is deflected radially inwardly towards the outer surface 76 of the rotatable shaft 20, allowing the retractable nub 66 to pass the bearing inner race 44 and to seat against the second axially spaced retaining nub 66A. Once the inner race 44 of the bearing assembly 40 has cleared the deflectable retaining nub or nubs 66 of the retainer nub 66 they will spring back into position in the radially outwardly extending position to thereby lock the shaft 20 in position with respect to the bearing assembly 40 supported in the tubular opening 56. In the embodiment illustrated, outer dimension 72 of the round sleeve 62 of the shaft support 60 is seated within the inner race 44 of the bearing assembly 40.

In the embodiments illustrated herein, the at least one deflectable retaining nubs 36 and 66 may comprise two or more nubs to thereby increase the retaining reliability of the retainer 30 and the shaft support 60, with respect to the bearing assembly 40 or other member being retained thereby. In an embodiment, the deflectable retaining nubs 36, 66 have ramped profiles such that insertion of the bearing 40, shaft 20 or other members into the opening 16 or shaft opening 56 and into a locked position is facilitated, but removal is prevented.

The embodiments illustrated and described herein have been directed to a novel retaining and support system that may be used to retain items such as bearings, shafts and the like in or on other mating assemblies without the use of traditional retaining devices such as c-clips that require the use of installation tools and the requisite access necessitated thereby. It is contemplated that the retaining and support system may be applicable to a range of retention applications and embodiments beyond those used to describe the inventive concepts herein. While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed, but that the invention will include all embodiments falling within the scope of the application.

What is claimed is:

1. A retainer system for fixedly retaining a member in an opening having an inner wall, the retainer system comprising:
a retainer comprising a sleeve having an outer dimension toleranced to fit within the inner wall, inwardly of the mouth of the opening, a first edge and a second edge and at least one deflectable retaining nub formed on the sleeve, and extending radially inwardly from the sleeve, between the first edge and the second edge; wherein
the retainer is configured to allow passage of the member therethrough, the deflectable retaining nub deflectable radially outwardly towards the inner wall of the opening; and wherein
the deflectable retaining nub returns to its radially inwardly extending position, when the member has cleared the deflectable retaining nub, locking the member in position in the opening.

2. The retainer system of claim 1, further comprising:
an inner stop disposed in the inner wall of the opening a distance “x” from the mouth of the opening;
the retainer disposed within the inner wall between the inner stop and the mouth of the opening; wherein
the member is locked in position between the deflectable retaining nub and the inner stop.

3. The retainer system of claim 2, further comprising:
an outer stop disposed in the inner wall of the opening a distance “Y” from the mouth of the opening, wherein “X”>“Y” and wherein the difference between “X” and “Y” is equal to a height “h” of the member;
an inner wall diameter “d” in the region between the inner stop and the outer stop;
an outer wall diameter “D” in the region between the outer stop and the mouth of the opening, wherein “D” is larger than “d”; wherein
the retainer is insertable into the opening and is seated against the outer stop with the deflectable retaining nub extending radially inwardly; wherein
the member is insertable into the opening and pressed through and past the retainer to seat against the inner bearing stop and; wherein
the deflectable retaining nub of the retainer returns to the radially inwardly extending position to thereby lock the member in position within the opening between the retainer and the inner stop.

4. The retainer system of claim 3, wherein the inner wall diameter “d” is equal to or less than the outer dimension of the member, and the diameter “D” is equal to or less than the outer dimension of the sleeve of the retainer.

5. The retainer system of claim 1, wherein the retainer further comprises:
first and second axially spaced deflectable retaining nubs formed on the sleeve of the retainer and extending radially inwardly from the sleeve between the first edge and the second edge such that the axial distance between the deflectable retaining nubs is equal to a height “h” of the member, wherein the member is insertable past the first deflectable retaining nub of the retainer to seat against the second, axially spaced retaining nub to thereby lock the member in position within the sleeve of the retainer and, as such, the opening, once the member has cleared the first retaining nub allowing it to spring back into position into the radially inwardly extending position.

6. The retainer system of claim 1, wherein the member comprises a bearing assembly including an outer race, an inner race and bearing members disposed between the inner and outer races to allow rotation therebetween.

7. The retainer system of claim 1, wherein, the retainer is press-fit within the opening.

8. The retainer system of claim 1, wherein the deflectable retaining nub is stamped into the round sleeve during forming of the retainer.

9. The retainer system of claim 5, wherein the deflectable retaining nubs are stamped into the round sleeve during forming of the retainer.

10. The retainer system of claim 1, wherein the sleeve is constructed from a thin walled tube of sheet steel, plastic, or composite.

11. A retainer system for fixedly retaining a bearing assembly in a housing, the retainer system comprising:
a housing including at least one opening having a mouth and defined by an inner wall;
a retainer comprising a sleeve having an outer dimension toleranced to fit within the inner wall, inwardly of the mouth, a first edge and a second edge and at least one deflectable retaining nub formed on the sleeve, and extending radially inwardly from the sleeve, between the first edge and the second edge; wherein
the retainer is configured to allow passage of a bearing assembly therethrough, the deflectable retaining nub deflecting radially outwardly towards the inner wall of the opening; and wherein
the deflectable retaining nub returns to its radially inwardly extending position, when the bearing assembly has cleared the deflectable retaining nub, locking the bearing assembly in position in the opening of the housing.

12. The retainer system of claim 11, further comprising:
an inner stop disposed in the inner wall of the opening a distance “X” from the mouth of the opening in the housing;
the retainer disposed within the inner wall between the inner stop and the mouth of the opening in the housing; wherein
the member is locked in position between the deflectable retaining nub and the inner stop.

13. The retainer system of claim 12, further comprising:
an outer stop disposed in the inner wall of the opening in the housing a distance “Y” from the mouth of the opening, wherein the difference between “X” and “Y” is equal to a height “h” of the bearing assembly;
an inner wall diameter “d” in the region between the inner stop and the outer stop;
an outer wall diameter “D” in the region between the outer stop and the mouth of the opening, wherein “D” is larger than “d”; wherein
the retainer is insertable into the opening in the housing and is seated against the outer stop with the deflectable retaining nub extending radially inwardly; wherein
the bearing assembly is insertable into the opening and may be pressed through and past the retainer to seat against the inner bearing stop and; wherein
the deflectable retaining nub of the retainer returns to the radially inwardly extending position to thereby lock the bearing assembly in position within the opening in the housing between the retainer and the inner stop.

14. The retainer system of claim 13, wherein the inner wall diameter “d” is equal to or less than the outer dimension of the bearing assembly, and the diameter “D” is equal to or less than the outer dimension of the sleeve of the retainer.

15. The retainer system of claim 11, wherein, the retainer is press-fit within the opening.

16. The retainer system of claim 11, wherein the deflectable retaining nub is stamped into the sleeve during forming of the retainer.

17. The retainer system of claim 11, wherein the sleeve is constructed from a thin walled tube of sheet steel, plastic, or composite.

18. The retainer system of claim 11, wherein the retainer further comprises:
first and second axially spaced deflectable retaining nubs formed on the sleeve of the retainer and extending radially inwardly from the sleeve between the first edge and the second edge such that the axial distance between the deflectable retaining nubs is equal to a height “h” of the bearing assembly, wherein the bearing assembly is insertable past the first deflectable retaining nub of the retainer and seats against the second, axially spaced retaining nub to thereby lock the bearing assembly in position within the sleeve of the retainer and, as such, the opening once the bearing assembly has cleared the first retaining nub allowing it to spring back into position into the radially inwardly extending position.

19. A retainer system for mounting a bearing assembly supported rotatable shaft in a tubular opening, the retainer system having a shaft support comprising:
a sleeve having an inner dimension “D1” toleranced to fit about the outer diameter of the rotatable shaft and an outer dimension “d1” toleranced to fit within an inner diameter of an inner race of the bearing assembly;
first and second axially spaced deflectable retaining nubs formed on the sleeve and extending radially outwardly from the sleeve between a first edge and a second edge such that the axial distance between the deflectable retaining nubs is equal to a bearing height “h”; wherein
the rotatable shaft with the shaft support in place is insertable into the bearing inner race and the first deflectable retaining nub is deflected radially inwardly towards the outer surface of the rotatable shaft until the first retaining nub is pressed past the bearing inner race and the second retaining nub seats against the bearing inner race to thereby lock the shaft in position in the bearing assembly, and the tubular passage, when the first deflectable retaining nub of the shaft support springs back into position in the radially outwardly extending position.

20. The retainer system of claim 1, wherein the deflectable retaining nub has a ramped profile.
